(19) United States
(12) Patent Application Publication
(10) Pub. No.: US 2016/0153309 A1
(43) Pub. Date: Jun. 2, 2016

(54) AIRCRAFT TURBOMACHINE HAVING AN AIR INLET OF VARIABLE SECTION

(71) Applicant: Airbus Operations (SAS), Toulouse (FR)

(72) Inventors: Guillaume Clairet, Toulouse (FR); Stephane Warnet, GRENADE SUR GARONNE (FR)

(21) Appl. No.: 14/950,942

(22) Filed: Nov. 24, 2015

(30) Foreign Application Priority Data
Nov. 27, 2014 (FR) 1461579

(51) Int. Cl. F01D 17/10; F01D 9/06; F01D 25/24

(52) U.S. Cl. CPC F01D 17/105; F01D 25/24; F01D 9/06; F05D 2220/323; F05D 2260/606; F05D 2260/52

(57) ABSTRACT

A turbomachine for an aircraft comprising a fan duct delimited by a wall and through which an air stream flows from upstream to downstream, and an air passage arranged in the wall comprising an air inlet opening flush with the wall, the air passage being designed to draw part of the air flow of the fan duct through the air inlet opening. To control the amount of air entering the air passage, a flap is rotatably mounted on the wall of the fan duct, about an axis of rotation disposed downstream of the air inlet opening, between an open position, in which the flap partially closes the air inlet opening and leaves free the fan duct downstream of the air inlet opening, and a closed position, in which the flap leaves open the air inlet opening and partially closes the fan duct downstream of the air inlet opening.

### CROSS-REFERENCES TO RELATED APPLICATIONS

This application claims the benefit of the French patent application No. 1461579 filed on Nov. 27, 2014, the entire disclosures of which are incorporated herein by way of reference.

### BACKGROUND OF THE INVENTION

The present invention relates to a turbomachine for an aircraft and to an aircraft comprising at least one such turbomachine.

A bypass turbomachine generally comprises an air admission system in order to provide air to an air-consuming system of the aircraft, such as the system for renewing the air in the cabin and for controlling the pressure thereof, or defrosting systems. The air admission system draws hot air from hot parts of the turbomachine and draws cool air from the fan duct of the turbomachine. So that the temperature of the air provided to the consumer systems remains below a limit temperature, the air admission system comprises an exchanger (PCE), in which the hot air exchanges calories with the cool air. The cool air is led to the exchanger via an air passage fluidically connecting the exchanger to the fan duct. The passage comprises an air inlet opening, operating in a scoop-like manner, at its upstream end. This inlet opening is flush with the wall of the fan duct so as to reduce the aerodynamic impact of the opening, in particular the drag thereof. However, with such a geometry an inlet opening cannot receive a flow of cool air sufficient for all cases of use of the air admission system of a turbomachine, in particular of a turbomachine having a high rate of dilution (greater than 13:1), in which case the temperature of the hot air drawn may exceed 550° C. (compared with 450 to 500° C. for other turbomachines). In particular, this is true for cases of extreme operation of the air admission system, i.e., when the demand of the air-consuming systems is high and is combined with a slow engine speed.

A solution suitable for such turbomachines in order to cover all cases of use of the air admission system would be to provide an air inlet opening of large dimension extending widely in the fan duct and combined with an exchanger having a large exchange surface. This solution cannot be accepted due to constraints relating to the available space in the turbomachine.

### SUMMARY OF THE INVENTION

There is thus a need to provide means for varying the amount of cool air directed toward the exchanger on the basis of the needs of the air admission system, which means do not have the disadvantages of the prior art. The object of the invention is to satisfy this need, and the invention relates to a turbomachine for an aircraft, comprising:
a fan duct delimited by a wall and through which a stream of air circulates from upstream to downstream, and
an air passage arranged in the wall and comprising an air inlet opening flush with the wall, the air passage being designed to draw part of the flow of the air of the fan duct through the air inlet opening,

wherein the turbomachine comprises a flap mounted rotatably on the fan duct wall, about an axis of rotation disposed downstream of the air inlet opening, between an open position, in which the flap partially closes the air inlet opening and leaves free the fan duct downstream of the air inlet opening, and a closed position, in which the flap leaves free the air inlet opening and partially closes the fan duct downstream of the air inlet opening.

Such a turbomachine thus comprises means for selecting the amount of air entering the air passage on the basis of the needs of the different devices of the aircraft.

Advantageously, the face of the flap oriented toward the fan duct is flush with the wall of the fan duct when the flap is in the closed position.

The turbomachine advantageously also comprises blocking means provided in order to assume, in turn, a first locking position, in which the means lock the flap in the closed position, and a second locking position, in which the means lock the flap in the open position.

The turbomachine advantageously also comprises a resilient means provided in order to displace the flap into the open position thereof when the blocking means are unlocked.

The turbomachine advantageously also comprises a return means provided in order to force the flap into the closed position when the blocking means are unlocked.

In accordance with a particular embodiment of the invention, the resilient means is a first torsion spring, the return means is a second torsion spring, and the second torsion spring is overdimensioned relative to the first torsion spring.

The invention also proposes an aircraft comprising at least one turbomachine according to one of the preceding variants.

### BRIEF DESCRIPTION OF THE DRAWINGS

The features of the invention mentioned above as well as further features will become clearer upon reading the following description of an exemplary embodiment, the description being provided with reference to the accompanying drawings, in which:

FIG. 1 shows an aircraft comprising a turbomachine according to the invention,

FIG. 2 is a schematic view of a section of a turbomachine according to the invention,

FIG. 3 is a schematic view showing the arrangement of an air admission system,

FIG. 4 shows a flap of the turbomachine according to the invention in a closed position,

FIG. 5 shows the flap of the turbomachine in an open position,

FIG. 6 shows a resilient means intended to help with the opening of the flap of the turbomachine according to the invention, and

FIG. 7 shows a return means intended to return the flap into its closed position.

### DETAILED DESCRIPTION OF THE PREFERRED EMBODIMENTS

FIG. 1 shows an aircraft 10, which comprises at least one bypass turbomachine 100, which is fixed here beneath a wing 12 of the aircraft 10 by means of a stub 14.

FIG. 2 shows a section of the bypass turbomachine 100 comprising an annular nacelle 102 centered on a longitudinal axis X and surrounding an engine 104.

In the direction of flow of a stream of air passing through the turbomachine 100 and indicated by the arrow F, the engine 104 comprises, centered on its longitudinal axis X, a fan 106, a body 108 and a nozzle 110.

In the following description, the terms “upstream” and “downstream” are to be considered relative to the direction of flow of the stream of air passing through the turbomachine 100.

The body 108 comprises elements making it possible to turn the fan 106 when the engine 104 is commissioned.

The turbomachine 100 additionally comprises, downstream of the fan 106, an annular vane partition 112 concentric with the body 108. The nacelle 102 forms the outer casing of the turbomachine 100 and surrounds the vane partition 112.

The vane partition 112 together with the body 108 delimits a first annular vane 114, and the vane partition 112 together with the nacelle 102 delimits a second annular vane, referred to as the fan duct 116. The annular vanes 114 and 116 extend as far as the nozzle 110.

The first vane 114 follows the body 108 and channels a stream of hot air HA, and the fan duct 116 channels a stream of cool air CA output by the fan 106.

The engine 104 is fixed to the nacelle 102 by means of two diametrically opposed bifurcations 118, which make it possible to ensure a mechanical cohesion of the turbomachine 100 and in particular connect therebetween the nacelle 102 and the vane partition 112.

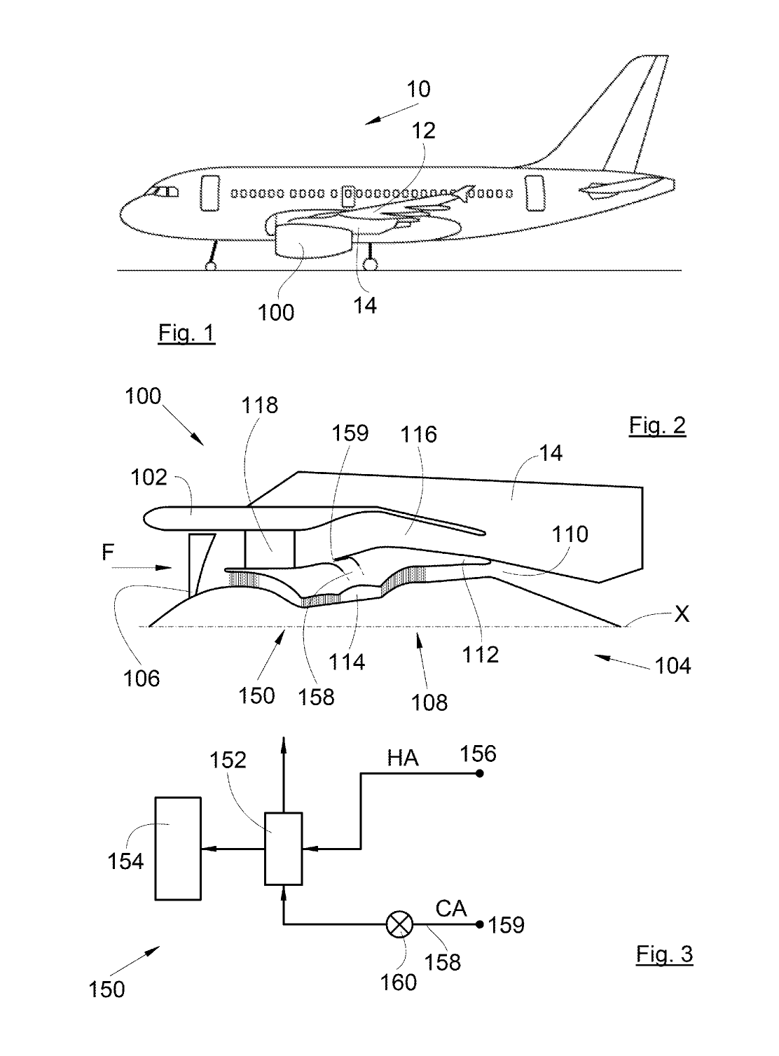

The turbomachine 100 also comprises an air admission system 150 intended to provide air to one or more air-consuming systems of the aircraft 10 and shown schematically in FIG. 3.

The air admission system 150 comprises, arranged for example in the thickness of the vane partition 112:
an air intake 156 intended to draw the hot air HA in the first annular vane 114,
an air passage 158 leading into the fan duct 116 via an air inlet opening 159 and designed to draw part of the flow of cool air CA from the fan duct 116 through the air inlet opening 159,
an exchanger 152 receiving, at the inlet, the stream of hot air HA from the air intake 156 and the stream of cool air CA from the air passage 158 passing herethrough perpendicularly in this case, an outlet of the exchanger being fluidically connected to at least one air-consuming system 154,
a regulating valve 160 disposed downstream of the air passage 158, between the air passage 158 and the exchanger 152 and fluidically connected to an inlet of the exchanger 152 and of which the angle of aperture is controlled on the basis of the cool flow needs of the exchanger 152 in order to ensure the provision of a suitable air temperature to the air-consuming systems 154.

The cool air CA is evacuated from the exchanger 152 either in the vane partition 112 or directly outside the strut 14. In the exchanger the hot air HA exchanges calories with the cool air CA. The hot air HA is cooled and evacuated via the outlet of the exchanger 152.

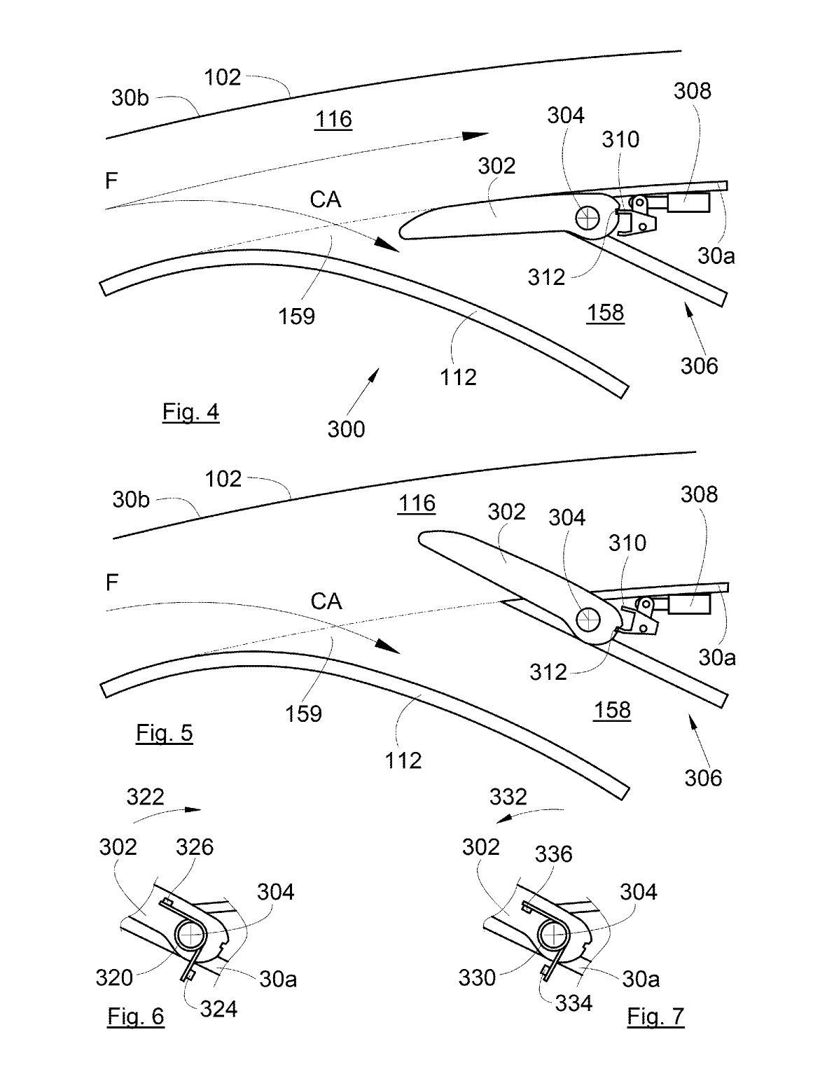

FIG. 4 and FIG. 5 show a detail of the peripheral zone of the air passage 158.

Although in the example described the air passage 158 and the air inlet opening 159 are arranged in the vane partition 112, they may also be arranged, without departing from the scope of the present invention, in the wall of the nacelle 102, i.e., more generally in the wall of the fan duct 116. In the embodiment of the invention presented in FIGS. 4 and 5, the wall of the fan duct 116 comprises the wall 30b of the nacelle 102 and the wall 30a of the vane partition 112. Their air inlet opening 159 is flush with the wall 30a, 30b of the fan duct 116.

The turbomachine 100 also comprises a regulation system 300 comprising a flap 302 mounted rotatably on the wall 30a of the fan duct 116, about an axis of displacement 304 disposed downstream of the air inlet opening 159, between an open position (FIG. 4), in which the flap 302 partially closes the air inlet opening 159 and leaves free the fan duct 116 downstream of the air inlet opening 159, and a closed position (FIG. 5), in which the flap 302 leaves free the air inlet opening 159 and partially closes the fan duct 116 downstream of the air inlet opening 159.

The mobility of the flap 302 thus makes it possible to vary the section of the air inlet 159 between a position with minimal opening of the air inlet 159 and a position with maximum opening of the air inlet 159 and to choose the amount of cool air that penetrates the air passage 158 and reaches the inlet of the exchanger 152.

The axis of displacement 304 is perpendicular to the stream of air F.

In order to avoid the development of aerodynamic drag in the fan duct 116, the face of the flap 302 oriented toward the fan duct 116 is flush with the wall 30a, 30b of the fan duct 116 when the flap 302 is in the closed position.

In order to block the flap 302 in the open position or closed position, the regulation system 300 also comprises blocking means 306, which can be activated remotely and are provided in order to assume, in turn, a first locking position (FIG. 4), in which they lock the flap 302 in the closed position, and a second locking position (FIG. 5), in which they lock the flap 302 in the open position.

The blocking means 306 are activated for example by an on-board computer of the aircraft 10 on the basis of different criteria, such as the speed of the aircraft 10 and the needs of the air-consuming systems 154.

In the embodiment of the invention presented in FIGS. 4 and 5 the blocking means 306 comprise a linear actuator 308, a latch 310 and a notch 312.

The notch 312 is formed on the flap 302.

The latch 310 has two teeth and is mounted rotatably about an axis of rotation parallel to the axis of displacement 304 below the wall 30a, 30b of the fan duct 116. The linear actuator 308 is also fixed below the wall 30a, 30b of the fan duct 116, and the movable end of the actuator is fixed to the latch 310 with the aid of a pivot link.

The linear actuator 308 assumes, in turn, a first position or a second position. The first position corresponds to the first locking position, and the latch 310 is arranged such that one of the teeth thereof sits in the notch 312, thus blocking the flap 302 in the closed position. The second position corresponds to the second locking position, and the latch 310 is arranged such that the other of its teeth sits in the notch 312, thus blocking the flap 302 in the open position.

The linear actuator 308 may be a pneumatic, electropneumatic or electromechanical actuator.

The blocking means 306 may take other forms. They may take the form of a linear actuator and two notches formed in the flap 302, and the movable end of the actuator sits in one or other of the notches depending on the position of the flap 302.

FIG. 6 shows a resilient means 320 provided in order to aid the opening of the flap 302 once the blocking means 306 have been unlocked. This resilient means 320 is provided in order to displace the flap 302 into its open position (arrow 322) when the blocking means 306 are unlocked. The resilient means 320 does not need to displace the flap 302 into its open position, instead it is sufficient to slightly lift the flap 302 so that the stream of air F catches under the flap 302 and opens it completely on account of the aerodynamic forces exerted.

The resilient means 320 is here a first pre-stressed torsion spring mounted coaxially with the axis of displacement 304 and of which one of the branches is pressed against a stop 324 of the wall 30a, 30b and of which the other branch is pressed against a stop 326 of the flap 302.

FIG. 7 shows a return means 330 provided in order to return the flap 302 from the open position to the closed position (arrow 332) when the blocking means 306 are unlocked. The return means 330 thus forces the flap 302 into the closed position when the blocking means 306 are unlocked.

The return means 330 may be a motor that pivots the flap 302 into the closed position thereof.

The flap is returned into the closed position when the motor 104 is stopped and there is therefore no more air to be circulated in the fan duct 116, and the flap 302 therefore is no longer subjected to an aerodynamic force forcing it into the open position. The return means 330 may then be a second pre-stressed torsion spring, which is also mounted coaxially with the axis of displacement 304 and which forces the flap 302 into the closed position when the blocking means 306 are unlocked. The second torsion spring 330 then has a branch that is pressed against a stop 334 of the wall 30a, 30b and another branch pressed against a stop 336 of the flap 302.

In order to overcome the resistance of the first torsion spring 320, the second torsion spring 330 is overdimensioned relative to the first torsion spring 320 in order to overcome the resistance of the first torsion spring during the return to the closed position and to pre-stress the first torsion spring.

A sequence of opening of the flap 302 comprises the following series of steps from the closed position of the flap 302 and when the blocking means 306 are in the first locking position and the engine 104 is commissioned:
the blocking means 306 are unlocked,
the opening of the flap 302 is initiated by the action of the resilient means 320 countering the aerodynamic moment,
the aerodynamic moment is inverted and takes over from the resilient means 320 and assures the complete opening of the flap 302, the aerodynamic moment stressing the return means 330 during this displacement, and
the blocking means 306 are locked in the second locking position.

At the end of a flight of the aircraft 10, a sequence of closure of the flap 302 comprises the series of following steps from the open position of the flap 302 and when the blocking means 306 are in the second locking position:
the engine 104 is switched off,
the blocking means 306 are unlocked,
the flap 302 is returned to its closed position by the action of the return means 330, the resilient means 320 being pre-stressed during this displacement,
the blocking means 306 are locked in the first locking position and the system is then reset.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A turbomachine for an aircraft, comprising:
a fan duct delimited by a wall and through which a stream of air circulates from upstream to downstream,
an air passage arranged in the wall and comprising an air inlet opening flush with the wall, the air passage being arranged to draw part of the flow of the air of the fan duct through said air inlet opening, and
a flap mounted rotatably on the wall of the fan duct, about an axis of rotation disposed downstream of the air inlet opening, between an open position, in which the flap partially closes the air inlet opening and leaves free the fan duct downstream of said air inlet opening, and a closed position, in which the flap leaves open the air inlet opening and partially closes the fan duct downstream of said air inlet opening.

2. The turbomachine as claimed in claim 1, wherein a face of the flap oriented toward the fan duct is flush with the wall of said fan duct when the flap is in the closed position.

3. The turbomachine as claimed in claim 1, further comprising blocking means when arranged in a first locking position, said means lock the flap in the closed position, and when arranged in a second locking position, said means lock the flap in the open position.

4. The turbomachine as claimed in claim 1, further comprising a resilient means arranged to displace the flap into the open position thereof when the blocking means are unlocked.

5. The turbomachine as claimed in one of claim 1, further comprising a return means provided in order to force the flap into the closed position when the blocking means are unlocked.

6. The turbomachine as claimed in claim 5, further comprising a resilient means arranged to displace the flap into the open position thereof when the blocking means are unlocked, wherein the resilient means is a first torsion spring, wherein the return means is a second torsion spring, and wherein the second torsion spring is overdimensioned relative to said first torsion spring.

7. An aircraft comprising:
at least one turbomachine comprising:
a fan duct delimited by a wall and through which a stream of air circulates from upstream to downstream,
an air passage arranged in the wall and comprising an air inlet opening flush with the wall, the air passage being arranged to draw part of the flow of the air of the fan duct through said air inlet opening, and
a flap mounted rotatably on the wall of the fan duct, about an axis of rotation disposed downstream of the air inlet opening, between an open position, in which the flap partially closes the air inlet opening and leaves free the fan duct downstream of said air inlet opening, and a closed position, in which the flap leaves open the air inlet opening and partially closes the fan duct downstream of said air inlet opening.
